(19) United States
(12) Patent Application Publication
(10) Pub. No.: US 2020/0079348 A1
(43) Pub. Date: Mar. 12, 2020

(54) METHOD FOR CONTROLLING DECELERATION OF VEHICLE USING FRONT DRIVING ENVIRONMENT INFORMATION

(71) Applicants: HYUNDAI MOTOR COMPANY, Seoul (KR); KIA MOTORS CORPORATION, Seoul (KR)

(72) Inventor: Do Hee KIM, Yongin-Si (KR)

(21) Appl. No.: 16/204,975

(22) Filed: Nov. 29, 2018

(30) Foreign Application Priority Data
Sep. 11, 2018 (KR) 10-2018-0108264

(51) Int. Cl. B60W 20/14; B60W 20/11; B60W 30/18; B60L 7/18; B60W 10/18

(52) U.S. Cl. CPC B60W 20/14; B60W 20/11; B60W 10/18; B60L 7/18; B60W 30/18127

(57) ABSTRACT

A method for controlling deceleration of a vehicle using front driving environment information includes: receiving, by a controller, the driving environment information in front of the vehicle; determining, by the controller, deceleration target speed of the vehicle based on the driving environment information; determining, by the controller, predicted deceleration energy based on the deceleration target speed; determining, by the controller, predicted charging energy that is charged by a driving motor of the vehicle to a battery supplying electric power to the driving motor based on the deceleration target speed; determining, by the controller, whether predicted hydraulic braking energy of the vehicle is generated based on the predicted deceleration energy and the predicted charging energy; and when the predicted deceleration energy is determined to exceed the predicted charging energy, controlling, by the controller, the driving motor to perform regenerative braking based on the predicted charging energy.

### CROSS-REFERENCE TO RELATED APPLICATION

This application claims priority to and the benefit of Korean Patent Application No. 10-2018-0108264 filed in the Korean Intellectual Property Office on Sep. 11, 2018, the entire contents of which are incorporated herein by reference.

### TECHNICAL FIELD

The present disclosure relates to a control method for a vehicle, and more particularly, to a method for controlling deceleration of an environmentally friendly vehicle using front driving environment information.

### BACKGROUND

An environmentally-friendly vehicle includes a fuel cell vehicle, an electric vehicle, a plug-in electric vehicle, and a hybrid vehicle, and typically includes a motor to generate driving force.

A hybrid vehicle, which is an example of the environmentally-friendly vehicle, uses an internal combustion engine and power of a battery together. In other words, the hybrid vehicle efficiently combines and uses power of the internal combustion engine and power of a motor.

The hybrid vehicle includes an engine, a motor, an engine clutch to adjust power between the engine and the motor, a transmission, a differential gear apparatus, a battery, a starter-generator that starts the engine or generates electricity by output of the engine, and wheels.

Further, the hybrid vehicle can consist of a hybrid control unit (HCU) for controlling an entire operation of the hybrid vehicle, an engine control unit (ECU) for controlling an operation of the engine, a motor control unit (MCU) for controlling an operation of the motor, a transmission control unit (TCU) for controlling an operation of the transmission, and a battery control unit (BCU) for controlling and managing the battery.

The battery control unit can be called a battery management system (BMS). The starter-generator can be called an integrated starter and generator (ISG) or a hybrid starter and generator (HSG).

The hybrid vehicle can be driven in a driving mode, such as an electric vehicle (EV) mode, which is an electric vehicle mode using only power of the motor, a hybrid electric vehicle (HEV) mode, which uses rotational force of the engine as main power and uses rotational force of the motor as auxiliary power, and a regenerative braking (RB) mode for collecting braking and inertial energy during driving by braking or inertia of the vehicle through electricity generation of the motor to charge the battery.

In a related art, there provides a method of calculating position information of a traffic light by detecting information (a position, a direction, a height) of a vehicle and information of the traffic light as an image and a color.

In another related art, there provides a method of providing traffic light information to a vehicle.

The above information disclosed in this Background section is only for enhancement of understanding of the background of the invention, and therefore it may contain information that does not form the prior art that is already known in this country to a person of ordinary skill in the art.

### SUMMARY

The present disclosure has been made in an effort to provide a method for controlling deceleration of an environmentally friendly vehicle using front driving environment information which is capable of performing a deceleration control for the vehicle using the front driving environment information (or traffic information) of the vehicle.

An exemplary embodiment of the present disclosure may provide a method for controlling deceleration of a vehicle using front driving environment information, including: receiving, by a controller, the driving environment information in front of the vehicle; determining, by the controller, a deceleration target speed of the vehicle based on the driving environment information; determining, by the controller, a predicted deceleration energy based on the deceleration target speed; determining, by the controller, a predicted charging energy that is charged by a driving motor of the vehicle to a battery that supplies electric power to the driving motor based on the deceleration target speed; determining, by the controller, whether a predicted hydraulic braking energy of the vehicle is generated based on the predicted deceleration energy and the predicted charging energy; and when the predicted deceleration energy is determined to exceed the predicted charging energy by the controller so that the predicted hydraulic braking energy is not generated, controlling, by the controller, the driving motor to perform a regenerative braking based on the predicted charging energy.

The method for controlling deceleration of the environmentally friendly vehicle may further include: when the predicted deceleration energy is determined to be equal to or less than the predicted charging energy by the controller so that the predicted hydraulic braking energy is generated, controlling, by the controller, a brake device of the vehicle to perform hydraulic braking corresponding to the predicted hydraulic braking energy; and after the hydraulic braking is performed, controlling, by the controller, the driving motor to perform a regenerative braking based on the predicted charging energy.

The driving environment information may include static traffic information and dynamic traffic information.

The determining the deceleration target speed of the vehicle may include: determining, by the controller, the deceleration target speed of the vehicle based on a limit speed of the vehicle included in static traffic information of the driving environment information and a traffic congestion degree of a road on which the vehicle decelerates. The controller may be configured to calculate the traffic congestion degree of the road using dynamic traffic information of the driving environment information.

The controller may be configured to calculate the traffic congestion degree of the road based on the number of vehicles in each road section, a distance of the road section, and an average speed of the vehicle in each road section included in traffic situation information of the dynamic traffic information.

The determining the predicted deceleration energy may include: calculating, by the controller, a driving load of the vehicle based on static traffic information of the driving environment information and a longitudinal driving load model of the vehicle; calculating, by the controller, predicted deceleration power based on the driving load and the deceleration target speed; and calculating, by the controller, the predicted deceleration energy based on the predicted deceleration power and a time that it takes for the vehicle to reach a deceleration event.

The determining the predicted charging energy may include: calculating, by the controller, a predicted motor charging energy that is charged to the battery by the driving motor based on energy conversion efficiency of the driving motor and electric power generated by the driving motor when a speed of the vehicle is changed to the deceleration target speed; calculating, by the controller, a predicted battery charging energy that is charged to the battery when a speed of the vehicle is changed to the deceleration target speed by subtracting the predicted motor charging energy from a current battery charging energy that is currently charged to the battery; and calculating, by the controller, the predicted charging energy by selecting a maximum value among the predicted battery charging energy and the predicted motor charging energy.

The controlling the brake device of the vehicle to perform the hydraulic braking may include: determining, by the controller, a time at which the predicted deceleration energy and the predicted charging energy are equal as a hydraulic braking start time and storing in a memory a reference speed of the vehicle to corresponding to the hydraulic braking start time; when a value obtained by subtracting the reference speed from a speed of the vehicle is less than a speed reference value, controlling, by the controller, the brake device of the vehicle to perform the hydraulic braking corresponding to the predicted hydraulic braking energy; and controlling, by the controller, the brake device to terminate the hydraulic braking when an actual hydraulic braking energy of the vehicle exceeds the predicted hydraulic braking energy.

The controller may be configured to calculate the actual hydraulic braking energy based on an actual hydraulic braking torque of the braking device, a driving wheel speed of the vehicle, and a gear ratio of a transmission included in the vehicle.

The controlling the brake device of the vehicle to perform the hydraulic braking may include: determining, by the controller, a time at which the predicted deceleration energy and the predicted charging energy are equal as a hydraulic braking start time and storing in a memory a reference speed of the vehicle to corresponding to the hydraulic braking start time; when a value obtained by subtracting an actual charging energy of the vehicle that is charged to the battery by the driving motor from an actual deceleration energy of the vehicle is less than an energy reference value, controlling, by the controller, the brake device of the vehicle to perform the hydraulic braking corresponding to the predicted hydraulic braking energy; and controlling, by the controller, the brake device to terminate the hydraulic braking when an actual hydraulic braking energy of the vehicle exceeds the predicted hydraulic braking energy.

The method for controlling deceleration of the environmentally friendly vehicle using the front driving environment information according to the exemplary embodiment of the present disclosure may control only the driving motor of the vehicle so that the vehicle is decelerated by regenerative braking without decelerating the vehicle by hydraulic braking when a battery margin for charging a battery that supplies electric power to the driving motor and a motor margin of the driving motor for charging the battery are sufficient. The exemplary embodiment of the present disclosure may predict a start time of the hydraulic braking to decelerate the vehicle using a predetermined braking amount at the start time when the battery margin or the motor margin is insufficient. Therefore, the braking amount of the vehicle by the driving motor may be increased (e.g., maximized), driving energy of the vehicle may be improved, and deceleration target speed of the vehicle may be effectively achieved.

### BRIEF DESCRIPTION OF THE DRAWINGS

A brief description of the drawings will be provided to more sufficiently understand the drawings which are used in the detailed description of the present disclosure.

FIG. 1 is a flowchart illustrating a deceleration control method for an environmentally friendly vehicle using front driving environment information according to an exemplary embodiment of the present disclosure.

FIG. 2 is a block diagram illustrating an environmentally friendly vehicle to which the deceleration control method shown in FIG. 1 is applied.

FIG. 3 is a view explaining a step of starting hydraulic braking shown in FIG. 1.

FIG. 4 is a view for explaining a step of terminating the hydraulic braking shown in FIG. 1.

### DETAILED DESCRIPTION OF THE EMBODIMENTS

In order to sufficiently understand the present disclosure and the object achieved by embodying the present disclosure, the accompanying drawings illustrating exemplary embodiments of the present disclosure and contents described in the accompanying drawings are to be referenced.

Hereinafter, the present disclosure will be described in detail by describing exemplary embodiments of the present disclosure with reference to the accompanying drawings. In describing the present disclosure, well-known configurations or functions will not be described in detail since they may unnecessarily obscure the gist of the present disclosure. Throughout the accompanying drawings, the same reference numerals will be used to denote the same components.

Terms used in the present specification are only used in order to describe specific exemplary embodiments rather than limiting the present disclosure. Singular forms are to include plural forms unless the context clearly indicates otherwise. It will be further understood that the terms “include” or “have” used in the present specification specify the presence of features, numerals, steps, operations, components, or parts mentioned in the present specification, or a combination thereof, but do not preclude the presence or addition of one or more other features, numerals, steps, operations, components, parts, or a combination thereof.

Throughout this specification and the claims that follow, when it is described that an element is “coupled” to another element, the element may be “directly coupled” to the other element or “electrically or mechanically coupled” to the other element through a third element.

Unless defined otherwise, it is to be understood that the terms used in the present specification including technical and scientific terms have the same meanings as those that are generally understood by those skilled in the art. It must be understood that the terms defined by the dictionary are identical with the meanings within the context of the related art, and they should not be ideally or excessively formally defined unless the context clearly dictates otherwise.

When a control that follows a deceleration target speed by predicting a deceleration target speed profile of an environmentally friendly vehicle using front driving information of the vehicle is performed so as to improve or optimize driving energy of the vehicle, hydraulic braking (or friction braking) of the vehicle may be required because there are charging limitation of a battery that supplies electric power to a driving motor of the vehicle and charging limitation of the driving motor charging the battery. Therefore, in order to smoothly follow the deceleration target speed of the vehicle, it is necessary to secure a motor torque margin of the driving motor or a charging margin of the battery by predicting a time at which the charging limitation occurs to perform the hydraulic braking in advance.

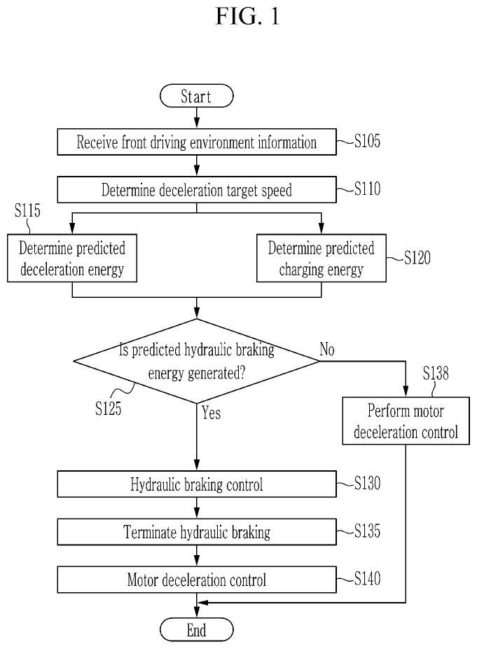

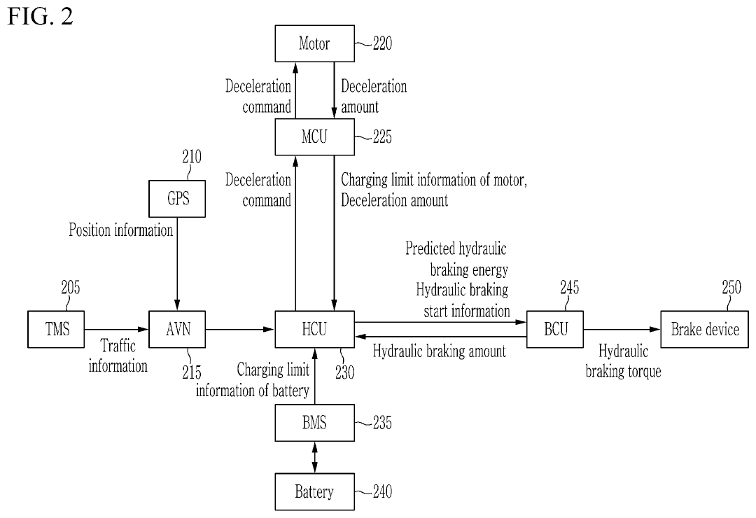

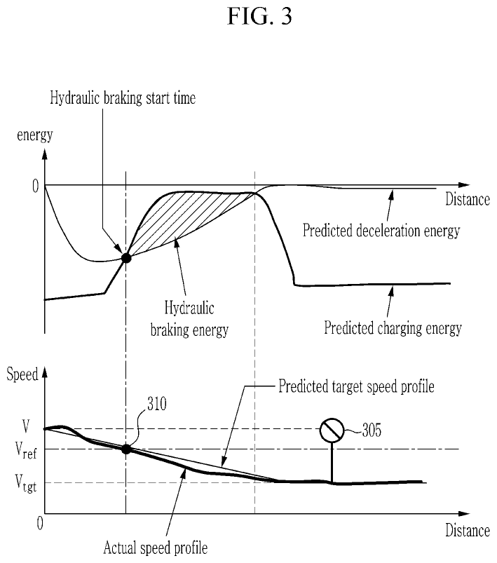

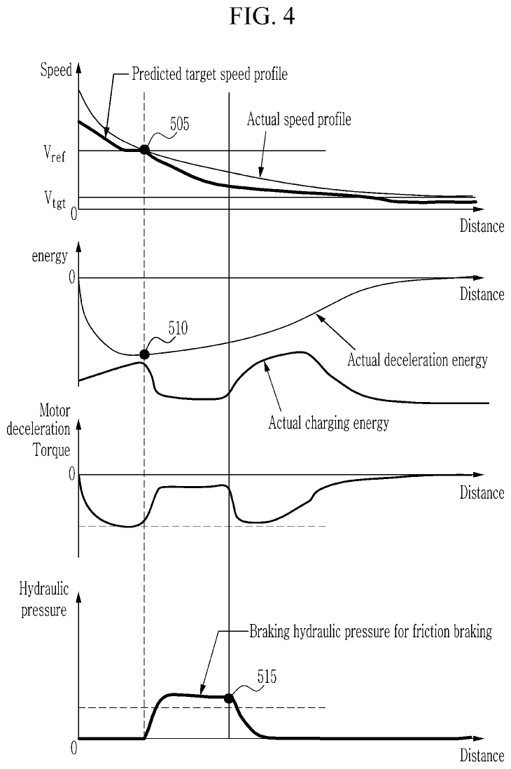

FIG. 1 is a flowchart illustrating a deceleration control method for an environmentally friendly vehicle using front driving environment information according to an exemplary embodiment of the present disclosure. FIG. 2 is a block diagram illustrating an environmentally friendly vehicle to which the deceleration control method shown in FIG. 1 is applied. FIG. 3 is a view explaining a step of starting hydraulic braking shown in FIG. 1. FIG. 4 is a view for explaining a step of terminating the hydraulic braking shown in FIG. 1.

Referring to FIGS. 1 to 4, in a receiving step S105, a controller included in the environmentally friendly vehicle may receive the driving environment information in front of the vehicle through a navigation device 215 such as an audio video navigation (AVN) device. The controller may include a hybrid control unit (HCU) 230, a motor control unit (MCU) 225, a brake control unit (BCU) 245, and a battery management system (BMS) 235.

For example, the controller such as an engine control unit (ECU) may be one or more microprocessors operated by a program or hardware including the microprocessor. The program may include a series of commands for executing the method for controlling deceleration of the environmentally friendly vehicle using the front driving environment information according to the exemplary embodiment of the present disclosure. The commands may be stored in a memory.

The environmentally friendly vehicle includes a global positioning system (GPS) receiver 210, the navigation device 215, a driving motor 220 such as an electric motor, the motor controller (MCU) 225, the hybrid controller (HCU) 230, the battery management system (BMS) device 235, a battery 240, the brake controller (BCU) 245, and a brake device (or a hydraulic braking device) 250. A telematics server (TMS) 205 may be a server disposed outside the environmentally friendly vehicle and may provide traffic information to the navigation device 215 of the environmentally friendly vehicle via communication. The navigation device 215 may receive or respond to position information of the environmentally friendly vehicle received from the GPS receiver 210 and traffic information received from the TMS 205 to generate the front driving environment information of the environmentally friendly vehicle, and may provide the driving environment information to the hybrid controller 230.

The hybrid controller 230 may be the highest controller, and may synthetically control controllers (for example, the MCU 225) connected to a network such as a controller area network (CAN) which is a vehicle network, and may control overall operation of the vehicle.

The hybrid controller 230 may transmit a deceleration command to the motor controller (MCU) 225 in response to the driving environment information. The motor controller (MCU) 225 may transmit charging limit information of the motor 220 to the hybrid controller 230 in response to the deceleration command. The motor charging limit information may indicate charging limitation of the driving motor 220 charging the battery 240 generated due to performance (or hardware specification) of the driving motor when regenerative braking of the environmentally friendly vehicle is performed. The regenerative braking may collect braking and inertial energy during driving by braking or inertia of the vehicle through electricity generation of the motor 220 driving a driving wheel of the vehicle to charge the battery 240. The driving by inertia of the vehicle may mean coasting drive. For example, when an object, a signal lamp, a curved road, and a vehicle is in front of the vehicle, energy may be collected from the coasting drive of the vehicle in a state where an accelerator pedal and a brake pedal of the vehicle are not depressed.

The motor controller (MCU) 225 may decelerate the driving motor 220 and may decelerate the environmentally friendly vehicle in response to the deceleration command. The driving motor 220 may transmit a deceleration amount to the hybrid controller 230 through the motor controller (MCU) 225.

The motor controller (MCU) 225 may control an output torque of the driving motor 220 through the network depending on the control signal output from the hybrid controller (HCU) 230, and thus may control the motor to operate at maximum efficiency. The MCU may include an inverter configured as a plurality of power switching elements. A power switching element included in the inverter may include an insulated gate bipolar transistor (IGBT), a field effect transistor (FET), a metal oxide semiconductor FET (MOSFET), a transistor, or a relay. The inverter converts a direct current (DC) voltage that is supplied from the battery 240 into a three-phase alternating current (AC) voltage to drive the driving motor 220.

The motor 220 may be operated by a three-phase AC voltage that is output from the MCU to generate a torque. The motor 220 may be operated as a generator during coasting drive or regenerative braking to supply a voltage (or regenerative energy) to the battery 240.

The Hybrid controller 230 may receive charging limit information of the battery 240 from the battery management system (BMS) 235. The battery charging limit information may indicate charging limitation of the battery 240 generated due to performance (or hardware specification) of the battery when regenerative braking of the environmentally friendly vehicle is performed.

The battery management system (BMS) 235 may monitor and manage a state of the battery 240 and may include a sensor that measures a state of charge (SOC) of the battery 240.

The battery 240 may include a plurality of unit cells. A high voltage for providing a driving voltage (for example, 350-450 V DC) to the motor 220 that provides driving power to the driving wheel of the vehicle may be stored in the battery.

The brake controller (BCU) 245 may generate a hydraulic braking torque for driving the brake device 250 in response to hydraulic braking start information and predicted hydraulic braking energy received from the hybrid controller (HCU) 230. The brake controller (BCU) 245 may transmit a hydraulic braking amount performed by the brake device 250 to the hybrid controller 230.

The front driving environment information may include static traffic information, and dynamic traffic information including traffic light information and traffic situation information. The static traffic information may be the high precision map including a road gradient, a road curvature, toll gate position, interchange (IC) position, road limit speed, left/right turn information for a vehicle, speed hump position information, or speed camera position information. The traffic light information may include a signal change period, a green signal time, a red signal time, a red signal remaining time, a green signal remaining time, a remaining distance to a traffic light, or position information of the traffic light. The traffic situation information may include the number of vehicles in each road section, a distance of a road section, or an average speed of a vehicle in each road section. Based on the traffic situation information, it may be determined whether a yellow signal time is included in the red signal time or in the green signal time. For example, the yellow signal time may be included in the green signal time when the vehicle traffic flow is determined to be smooth based on the traffic situation information, and the yellow signal time may be included in the red signal time when the vehicle traffic flow is determined not to be smooth based on the traffic situation information. For safety of the vehicle, the yellow signal time may always be included in the red signal time.

According to a determination step S110, the controller may determine a deceleration target speed V_{tgt} (or a deceleration target speed profile that is a predicted value) of the environmentally friendly vehicle based on the driving environment information. For example, the controller may determine or calculate the deceleration target speed of the environmentally friendly vehicle based on a limit speed of the environmentally friendly vehicle included in the static traffic information and a traffic congestion degree of a road on which the vehicle decelerates. The controller may calculate the traffic congestion degree of the road based on the number of vehicles in each road section, a distance of the road section, and an average speed of the vehicle in each road section included in the traffic situation information of the dynamic traffic information.

According to a determination step 115, the controller may determine a predicted deceleration energy (e.g., a predicted deceleration required energy having a negative value) based on the deceleration target speed.

For example, the controller may calculate a driving load FR of the environmentally friendly vehicle using the static traffic information including the road gradient and the road curvature and the following equations according to a longitudinal driving load model of the environmentally friendly vehicle.

The driving load=a load due to air resistance+a load due to rolling resistance+a load due to gradient resistance

F_{R}=½ρC_{d}AV²+mg(μ·cos β+sin β)

In the above equation, the p may be atmospheric air density (kg/m³), the C_{d} may be an air resistance coefficient and may have a negative sign, the A may be a frontal area of the environmentally friendly vehicle (m²), the V may be a speed of the environmentally friendly vehicle that is the deceleration target speed, the m may be weight of the environmentally friendly vehicle, the g may be acceleration of gravity, the 1 may be a resistance coefficient, and the P may be an inclination angle or a slope of a road on which the environmentally friendly vehicle travels.

The controller may calculate predicted deceleration power by multiplying the driving load by the deceleration target speed. The controller may calculate or determine the predicted deceleration energy by multiplying the predicted deceleration power by a time that it takes for the environmentally friendly vehicle to reach a deceleration event (e.g., a toll gate, an interchange (IC), a speed camera, left/right turn of a vehicle, or a traffic signal).

According to a determination step S120, the controller may determine a predicted charging energy that will be charged by the driving motor 220 to the battery 240 that supplies electric power to the driving motor based on the deceleration target speed.

For example, the controller may calculate a predicted motor charging energy that can be charged to the battery 240 by the driving motor 220 using the following equation.

Predicted motor charging energy=∫(Energy conversion efficiency of motor×Predicted motor power)dt

In the above equation, the predicted motor power may mean electric power generated by the driving motor 220 when a speed of the environmentally friendly vehicle becomes the deceleration target speed.

The controller may calculate a predicted battery charging energy that can be charged to the battery 240 when a speed of the environmentally friendly vehicle is changed to the deceleration target speed by subtracting the predicted motor charging energy from a current battery charging energy that can currently be charged to the battery. The controller may calculate the predicted charging energy by selecting a maximum value among the predicted battery charging energy and the predicted motor charging energy. The predicted battery charging energy and the predicted motor charging energy may have negative values.

According to a determination step S125, the controller may determine whether the predicted hydraulic braking energy of the environmentally friendly vehicle is generated based on the predicted deceleration energy and the predicted charging energy.

For example, the controller may determine or calculate the predicted hydraulic braking energy by subtracting the predicted charging energy from the predicted deceleration energy.

When the predicted deceleration energy is determined to exceed the predicted charging energy by the controller so that the predicted hydraulic braking energy is not generated or the predicted hydraulic braking energy is not present, a process, which is the deceleration control method of the environmentally friendly, may proceed to a control step S138. When the predicted deceleration energy is determined to be equal to or less than the predicted charging energy by the controller so that the predicted hydraulic braking energy is generated or the predicted hydraulic braking energy is present, the process may proceed to a control step S130.

According to a control step S138, the controller may control the driving motor 220 to perform the regenerative braking based on the predicted charging energy. The predicted charging energy may be determined based on a margin of the driving motor 220 that can be charged and a margin of the battery 240 that can be charged.

According to the control step S130, the controller may control the brake device 250 to start or perform hydraulic braking corresponding to the predicted hydraulic braking energy.

For example, as shown in FIGS. 3 and 4, the controller may determine a time at which the predicted deceleration energy and the predicted charging energy are equal as a hydraulic braking start time, and may store in the memory a reference speed V_{ref} (i.e., a reference numeral 310 in FIG. 3 or a reference numeral 505 in FIG. 4) of the environmentally friendly vehicle that corresponds to the hydraulic braking start time. Horizontal axes of graphs shown in FIGS. 3 and 4 may indicate a distance until the environmentally friendly vehicle reaches a deceleration event 305 or a time that it takes for the environmentally friendly vehicle to reach the deceleration event 305.

As shown in FIG. 3, when a value obtained by subtracting the reference speed V_{ref} from a speed (or an actual speed) of the environmentally friendly vehicle is less than a speed reference value or when the speed (or the actual speed) of the environmentally friendly vehicle is decelerated to the reference speed V_{ref}, the controller may control the brake device 250 of the environmentally friendly vehicle to start the hydraulic braking corresponding to the predicted hydraulic braking energy. The speed of the environmentally friendly vehicle may be detected by a speed sensor of the environmentally friendly vehicle so that the detected speed is provided to the controller. The speed sensor may be mounted on the driving wheel of the environmentally friendly vehicle.

In another exemplary embodiment of the present disclosure, as shown in FIG. 4, when a value obtained by subtracting an actual charging energy of the environmentally friendly vehicle from an actual deceleration energy of the environmentally friendly vehicle is less than an energy reference value, the controller may control the brake device 250 of the environmentally friendly vehicle to start the hydraulic braking corresponding to the predicted hydraulic braking energy. In FIG. 4, a reference numeral 510 may indicate a time when the actual deceleration energy maximally approaches the actual charging energy. The actual deceleration energy and the actual charging energy may have negative values. The controller may calculate the actual deceleration energy and the actual charging energy using a value detected by a sensor device including the speed sensor and the battery SOC sensor.

According to a control step S135, the controller may control the brake device 250 to end the hydraulic braking corresponding to the predicted hydraulic braking energy.

When an actual hydraulic braking energy of the environmentally friendly vehicle exceeds the predicted hydraulic braking energy, as shown in FIG. 4, the controller may control the brake device 250 of the environmentally friendly vehicle to end the hydraulic braking corresponding to the predicted hydraulic braking energy. In FIG. 4, a reference numeral 515 may indicate a time when the actual hydraulic braking energy exceeds the predicted hydraulic braking energy.

The controller may calculate the actual hydraulic braking energy using the following equation.

Actual hydraulic braking energy=∫(Actual hydraulic braking torque of brake device×Driving wheel speed of vehicle×Gear ratio of transmission of vehicle)dt

According to a control step S140, after the hydraulic braking is performed, the controller may control the driving motor 220 to perform the regenerative braking based on the predicted charging energy. The predicted charging energy may be determined based on a margin of the driving motor 220 that can be charged and a margin of the battery 240 that can be charged.

As described above, the exemplary embodiment of the present disclosure may predict in advance a case where the hydraulic braking is required in the deceleration event according to the driving environment information in front of the environmentally friendly vehicle to perform the hydraulic braking in order to secure the margins of the motor and the battery. Thus, the regenerative braking and the deceleration target speed of the vehicle may be effectively achieved.

The components, “˜unit”, block, or module which are used in the present exemplary embodiment may be implemented in software such as a task, a class, a subroutine, a process, an object, an execution thread, or a program which is performed in a predetermined region in the memory, or hardware such as a field programmable gate array (FPGA) or an application-specific integrated circuit (ASIC), and may be performed with a combination of the software and the hardware. The components, ‘˜part’, or the like may be embedded in a computer-readable storage medium, and some part thereof may be dispersedly distributed in a plurality of computers.

As set forth above, exemplary embodiments have been disclosed in the accompanying drawings and the specification. Herein, specific terms have been used, but are just used for the purpose of describing the present disclosure and are not used for qualifying the meaning or limiting the scope of the present disclosure, which is disclosed in the appended claims. Therefore, it will be understood by those skilled in the art that various modifications and equivalent exemplary embodiments are possible from the present disclosure.

Accordingly, the actual technical protection scope of the present disclosure must be determined by the spirit of the appended claims.

What is claimed is:

1. A method for controlling deceleration of a vehicle using front driving environment information, the method comprising steps of:
receiving, by a controller, the driving environment information in front of the vehicle;
determining, by the controller, a deceleration target speed of the vehicle based on the driving environment information;
determining, by the controller, a predicted deceleration energy based on the deceleration target speed;
determining, by the controller, a predicted charging energy that is charged by a driving motor of the vehicle to a battery that supplies electric power to the driving motor based on the deceleration target speed;
determining, by the controller, whether a predicted hydraulic braking energy of the vehicle is generated based on the predicted deceleration energy and the predicted charging energy; and
when the predicted deceleration energy exceeds the predicted charging energy by the controller so that the predicted hydraulic braking energy is not generated, controlling, by the controller, the driving motor to perform regenerative braking based on the predicted charging energy.

2. The method of claim 1, further comprising steps of:
when the predicted deceleration energy is equal to or less than the predicted charging energy by the controller so that the predicted hydraulic braking energy is generated, controlling, by the controller, a brake device of the vehicle to perform hydraulic braking corresponding to the predicted hydraulic braking energy; and
after the hydraulic braking is performed, controlling, by the controller, the driving motor to perform regenerative braking based on the predicted charging energy.

3. The method of claim 1, wherein the driving environment information includes static traffic information and dynamic traffic information.

4. The method of claim 1, wherein the step of determining the deceleration target speed of the vehicle comprises a step of:
determining, by the controller, the deceleration target speed of the vehicle based on a limit speed of the vehicle included in static traffic information of the driving environment information and a traffic congestion degree of a road on which the vehicle decelerates,
wherein the controller is configured to calculate the traffic congestion degree of the road using dynamic traffic information of the driving environment information.

5. The method of claim 4, wherein the controller is configured to calculate the traffic congestion degree of the road based on a number of vehicles in each road section, a distance of each road section, and an average speed of the vehicle in each road section included in traffic situation information of the dynamic traffic information.

6. The method of claim 1, wherein the step of determining the predicted deceleration energy comprises steps of:
calculating, by the controller, a driving load of the vehicle based on static traffic information of the driving environment information and a longitudinal driving load model of the vehicle;
calculating, by the controller, predicted deceleration power based on the driving load and the deceleration target speed; and
calculating, by the controller, the predicted deceleration energy based on the predicted deceleration power and a period of time for the vehicle to reach a deceleration event.

7. The method of claim 1, wherein the step of determining the predicted charging energy comprises steps of:
calculating, by the controller, a predicted motor charging energy that is charged to the battery by the driving motor based on energy conversion efficiency of the driving motor and electric power generated by the driving motor when a speed of the vehicle is changed to the deceleration target speed;
calculating, by the controller, a predicted battery charging energy that is charged to the battery when a speed of the vehicle is changed to the deceleration target speed by subtracting the predicted motor charging energy from a current battery charging energy that is currently charged to the battery; and
calculating, by the controller, the predicted charging energy by selecting a greater value between the predicted battery charging energy and the predicted motor charging energy.

8. The method of claim 2, wherein the step of controlling the brake device of the vehicle to perform the hydraulic braking comprises steps of:
determining, by the controller, a time at which the predicted deceleration energy and the predicted charging energy become equal as a hydraulic braking start time, and storing, in a memory, a reference speed of the vehicle to corresponding to the hydraulic braking start time;
when a value obtained by subtracting the reference speed from a speed of the vehicle is less than a speed reference value, controlling, by the controller, the brake device of the vehicle to perform the hydraulic braking corresponding to the predicted hydraulic braking energy; and
controlling, by the controller, the brake device to terminate the hydraulic braking when an actual hydraulic braking energy of the vehicle exceeds the predicted hydraulic braking energy.

9. The method of claim 8, wherein the controller is configured to calculate the actual hydraulic braking energy based on an actual hydraulic braking torque of the braking device, a driving wheel speed of the vehicle, and a gear ratio of a transmission included in the vehicle.

10. The method of claim 2, wherein the step of controlling the brake device of the vehicle to perform the hydraulic braking comprises steps of:
determining, by the controller, a time at which the predicted deceleration energy and the predicted charging energy become equal as a hydraulic braking start time, and storing, in a memory, a reference speed of the vehicle to corresponding to the hydraulic braking start time;
when a value obtained by subtracting an actual charging energy of the vehicle that is charged to the battery by the driving motor from an actual deceleration energy of the vehicle is less than an energy reference value, controlling, by the controller, the brake device of the vehicle to perform the hydraulic braking corresponding to the predicted hydraulic braking energy; and
controlling, by the controller, the brake device to terminate the hydraulic braking when an actual hydraulic braking energy of the vehicle exceeds the predicted hydraulic braking energy.
